(19) United States
(12) Patent Application Publication
(10) Pub. No.: US 2011/0286641 A1
(43) Pub. Date: Nov. 24, 2011

(54) Sensor System Having A Platen With A Dome-Shaped Contact Surface

(76) Inventors: John K. Schneider, Snyder, NY (US); Jack C. Kitchens, Tonawanda, NY (US)

(21) Appl. No.: 13/111,392

(22) Filed: May 19, 2011

Related U.S. Application Data
(60) Provisional application No. 61/346,076, filed on May 19, 2010.

(51) Int. Cl. G06K 9/00

(52) U.S. Cl. 382/124

(57) ABSTRACT

A sensor system and a method for collecting information about a surface of an object are disclosed. The sensor has a plurality of detectors and a platen. The platen has a contact surface, at least part of which is dome-shaped. When the surface of an object is in contact with the contact surface, an energy signal may be sent to toward the contact surface, and the detectors may detect the reflected signal. The detected signal may be used to provide information about the object's surface, including an image of the surface.

### CROSS-REFERENCE TO RELATED APPLICATION

This application claims the benefit of priority to U.S. provisional patent application Ser. No. 61/346,076, filed on May 19, 2010.

### FIELD OF THE INVENTION

The present invention relates to scanners. More specifically, the present invention relates to swipe-type fingerprint scanners, where a finger is moved over sensing elements and multiple images of the finger are obtained, which are later combined to form an image of the friction ridge surface of the fingerprint.

### BACKGROUND OF THE INVENTION

Although small fingerprint scanners have been around for many years, a drawback to these systems is the flat platen that is used for contact with the friction skin surface of the finger. Since human fingers are not flat, the friction skin surface that is being imaged typically has regions, such as the crease line at finger joints, where contact with the imaging platen is less than perfect. In these situations, a small amount of the finger friction skin does not adequately contact the imaging surface and results in areas of the fingerprint image that provide little or no detail about that part of the friction ridge.

From a human factors perspective, a platen having a flat contact surface is not optimum for maximizing the area that can be imaged. To better meet this human factors consideration, the present invention provides a platen, at least part of which is not flat. That part of the platen of the fingerprint scanner that is available to contact the friction ridge skin of the finger is preferably convexly curved to better allow contact with the skin and folds or creases of the skin.

### SUMMARY OF THE INVENTION

The invention may be embodied as a sensor system having a platen and an array sensor. The platen has a contact surface, at least part of which is dome-shaped. The dome-shape may be a para-ellipsoidal shape. The array sensor has a plurality of detectors, which may be arranged in a line, or as an area-array. Energy reflected from the interface of the contact surface and an object touching the contact surface is detected by the detectors and used to provide information about the object.

The detectors may be ultrasonic energy detectors. In such a system, each detector may be associated with a time-delay window corresponding to a signal-travel-distance. The signal-travel-distance is the distance generated energy travels starting from the generator to the contact surface where it is reflected, plus the distance from the contact surface to the detector. The time-delay window is the period of time during which an energy signal is expected to arrive at the detector. Some of the detectors have a time-delay window that starts at a different time than the time-delay window of other detectors in the array sensor.

The invention may be embodied as a method for collecting information about the surface of an object, such as the skin surface of a finger. In one such method, a sensor system is provided. The sensor system may have a platen and a plurality of detectors. The platen may have a contact surface, at least part of which is dome-shaped. An object, such as a skin surface, that is contacting the contact surface is moved across the platen while an energy signal is emitted toward the platen. The energy signal may be an ultrasonic longitudinal wave. Using the detectors, energy that is reflected from the interface of the contact surface and the object is detected, and may be used to provide information about the object. For example, the detected signal may be used to generate an image of the object's surface.

### BRIEF DESCRIPTION OF THE DRAWINGS

For a fuller understanding of the nature and objects of the invention, reference should be made to the accompanying drawings and the subsequent description. Briefly, the drawings are:

FIG. 1 depicts a contact surface of a platen that is in keeping with the invention. The contact surface is para-ellipsoidal in shape, and in this particular embodiment the contact surface is para-spheroidal.

FIG. 2A shows a human finger.

FIG. 2B shows a human finger contacting a flat platen of a prior art fingerprint scanner.

FIG. 2C shows a human finger contacting a para-ellipsoidal platen of a fingerprint scanner that is in keeping with the invention.

FIG. 3 shows a contact surface that is in keeping with the invention and is substantially flat in the center region, and curved at the edges.

FIG. 4 depicts a scanner according to the invention.

FIG. 5 is a flow chart of a method that is in keeping with the invention.

FIG. 6 is a flow chart of a method that is in keeping with the invention.

### FURTHER DESCRIPTION OF THE INVENTION

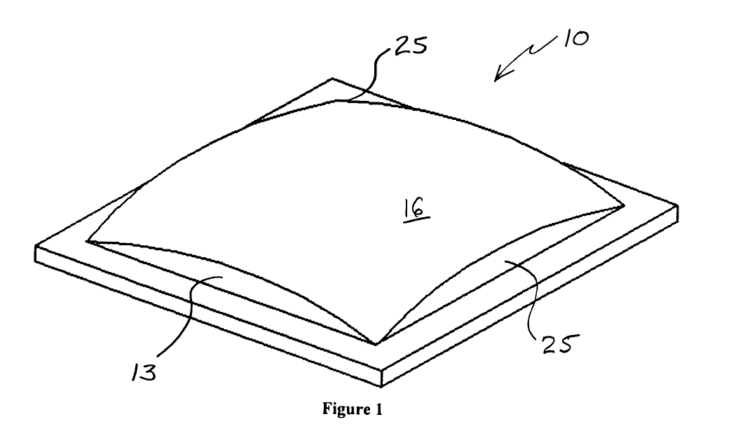

FIGS. 1, 2C, 3 and 4 depict embodiments of the invention. The invention may be embodied as a fingerprint scanner 10 having a platen 13 with a para-ellipsoidal contact surface 16. The para-ellipsoidal contact surface 16 is a convexly shaped surface that resembles part of an ellipsoid and is available to receive an object, such as a finger 19. All lines that could be drawn on the para-ellipsoidal portion of the contact surface will be curved, and thus the platen 13 is distinguished from cylindrical platens. The eccentricity of the para-ellipsoidal contact surface 16 may range from zero (and hence a para-spheroid) to almost one.

The para-ellipsoidal contact surface 16 may more closely match the shape of a human finger 19, and allows for the acquisition of information from areas of the friction ridge that would be difficult to image with a flat platen. By providing a para-ellipsoidally curved contact surface 16 for the platen 13, the finger 19 contacts the platen 13 in a manner that allows more complete contact with the friction ridge surface of the skin, which in turn provides more complete information about the friction ridge surface.

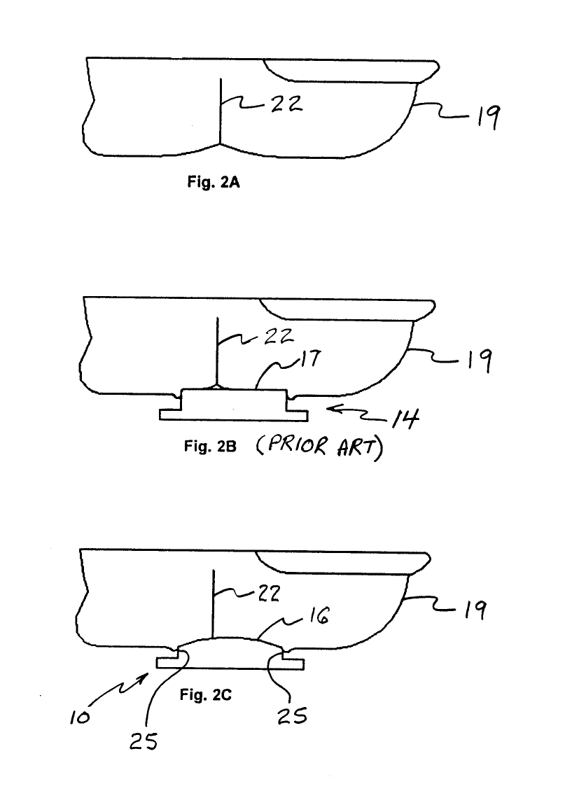

FIG. 1 depicts a platen 13 having a convexly curved contact surface 16. By providing the platen 13 with a convexly curved contact surface 16 instead of a flat surface, contact between the finger 19 and the platen 13 is enhanced, and the scanner 10 is better able to acquire a fingerprint image of the friction ridge surface near and/or within the folds of the skin, such as at the bending joints 22 between segments of a finger (see FIG. 2A).

FIG. 2B depicts a finger 19 on a platen 14 having a flat contact surface 17. It should be noticed that the skin bunches at the edge of such a platen 14, and the bending joint 22 is not in contact with the platen 14. In contrast, FIG. 2C has a platen 13 with a para-ellipsoidal contact surface 16, and here the bending joint 22 contacts the platen 13. Also, bunching of the skin at the edges of the platen 13 is reduced.

In a typical scanning system that could be deployed on an appliance, such as a cell phone or a laptop computer, the available area on the appliance that may be used for the fingerprint scanner 10 is limited. Typical scanners used in these systems may be limited in size to not more than 8 mm by 8 mm. To function within such a size limitation, the scanners are usually of the swipe-type, which require the user to move (e.g. by rolling or dragging) his finger over the platen 13 to present as much skin to the device as is necessary. To maximize the collected skin surface image, a convexly shaped contact surface 16 that is in keeping with the invention is useful. The convexly shaped contact surface 16 may be a para-ellipsoid shape or other dome-shape. It should be noted that all lines that could be drawn on the dome-shaped portion of the contact surface 16 will be curved, and thus the contact surface is distinguished from cylindrical platens.

For example, the dome-shaped portion of the contact surface 16 may be a para-spheroid having a curvature defined by the ratio of (i) the perpendicular distance from the spherical chord to the center of the spherical arc described by the chord, and (ii) the length of the chord. Using FIG. 1 as an example, if the footprint of the platen 13 is 8 mm×8 mm, and the change in “elevation” from one of the corners to the peak of the domed contact surface 16 is 0.2 mm, then the chord is 11.312 mm in length and the perpendicular distance from the chord to the center of the arc is 0.2 mm. Consequently, the ratio describing the para-spheroidal segment is 0.2:11.312, or 1:56.5. It is anticipated that some platens 13 may have more curvature, and that a ratio of as much as 1:19 (or more) might be common.

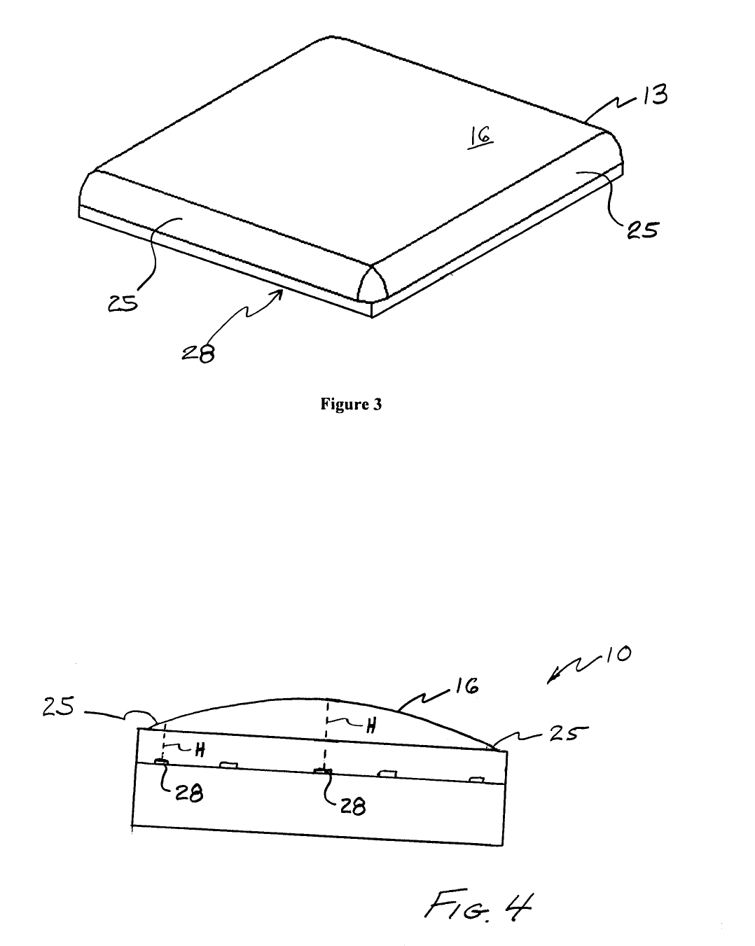

As an alternative, the platen 13 may be predominantly flat in its central region, but convexly curved at its edges 25. FIG. 3 depicts one such platen 13. This configuration affords the advantage of aesthetics and user comfort from a human factors design, and provides the benefits of the convexly curved contact surface 16 to areas of the finger 19 that are most likely to have portions that are difficult to image because of a joint 22 or overlapping skin. The platen 13 depicted in FIG. 3 permits information about the friction ridge skin that is in contact with the flat and curved surfaces of the platen 13 to be obtained by a detector 28 (see FIG. 4) that is positioned “beneath” the platen 13.

The convexly curved platen 13 shown in FIG. 1 may be thick in its center and thin at the edges 25, and the thickness of the platen 13 changes as one moves from the center of the contact surface 16 of the platen 13 to the edges 25 of the contact surface 16 of the platen 13. Such a platen is shown in FIG. 4. Consequently, the finger 19 may be closer to the detectors 28 at an edge 25 of the contact surface 16 than the finger 19 is at the center of the contact surface 16. FIG. 4 depicts this aspect of the device. In FIG. 4, the device used to generate an ultrasonic energy wave is also used to detect energy that is reflected at the interface of the contact surface 16. Because the contact surface 16 of the platen 13 is not uniformly distanced from the detectors 28 (five of which are depicted), the reflected energy from the contact surface 16 may not arrive at the detectors 28 at the same time. For example, the time for the energy to travel to and from the finger 19 will be less for those portions of the finger 19 that are nearer the edge 25 of the platen 13 than for those portions of the finger 19 that are nearer to the center of the platen 13. Furthermore, there may be refractive effects that further complicate the process of gathering information about the finger 19, and producing an image. To accommodate, a lookup table may be used so that information gathered by detectors 28 from one portion of the sensor array is adjusted according to a first set of instructions in the lookup table, and information gathered by detectors 28 from a different portion of the sensor array is adjusted according to a second set of instructions in the lookup table.

By using a curved surface for the platen 13, certain advantages may be achieved without making it difficult for the scanner 10 to obtain the information needed to create an image of the object's surface. For instance, in the case of an ultrasonic imaging system, the system relies upon knowledge of the length of time between issuance of an insonification pulse and receipt of the echo generated from the fingerprint that is in contact with the contact surface 16 of the platen 13. Since many of these systems utilize digital technology, with each pixel location having its own detector 28, it is a simple task to pre-measure or pre-calculate these variations in pulse-echo time and simply store the delay times in digital memory for use in acquiring the information needed to generate an image of the object's surface.

Some embodiments of the invention may use light as the energy being detected by the detectors 28. In those systems, because the speed of light is very large compared to the distance traveled in such a scanner 10, the travel time of the light is extremely short, regardless of the location of the detector 28, and thus presents less of a problem with respect to when the reflected energy will arrive. Often the difference in time of arrival for the light energy can be ignored.

If an optical scanning system is used, then the dome-shaped platen 13 may require that the platen be fabricated from an optical image conduit. Such an optical image conduit may be a bundle of substantially parallel optical fibers used for the purpose of conducting the energy reflected at the contact surface 16 to the optical detectors 28 while allowing lateral spreading of the optical energy. An acoustic waveguide array may be used in a similar fashion for a system using ultrasonic detectors 28.

Embodiments with non-fiber means may also be used, but accommodations must be provided for refractive spread of the signals carrying the fingerprint information. These embodiments can be micro-lens arrays, or a simple mapping strategy where the distortion effects from diffraction are characterized and stored in digital memory for use in the fingerprint geometry algorithm.

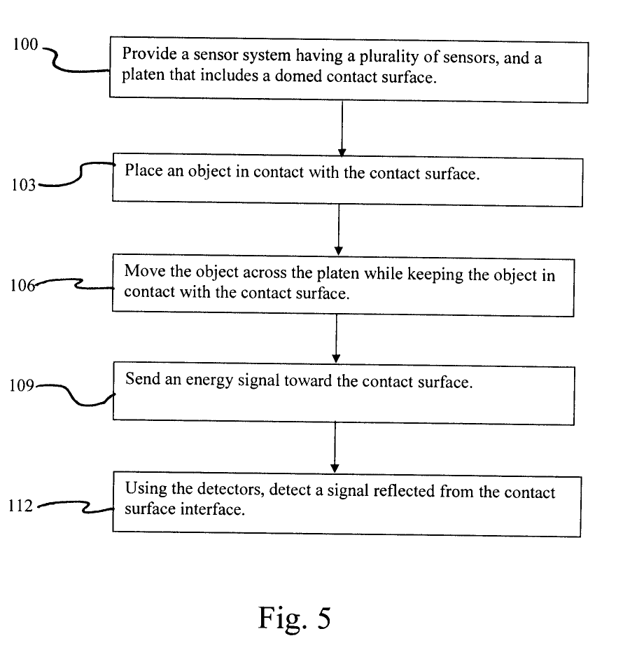

Having provided a general overview of the invention, additional details about the inventive sensor system will be provided below by describing a method that is in keeping with the invention. FIG. 5 depicts such a method. A sensor system is provided 100 and ultimately used to obtain information about an object, such as a finger. The sensor system has a platen and a plurality of detectors. The detectors may be arranged in a line or as an area-array. An area-array sensor may be formed by having detectors distributed across the length and width of a planar substrate. The platen has a contact surface, at least part of which is dome-shaped, and may be a para-ellipsoid—that is to say that the contact surface is shaped like part of an ellipsoid. An object, such as the friction ridge surface of a finger is placed in contact 103 with the contact surface. The surface of the object that is contacting the contact surface may be moved 106 across the contact surface while energy is directed 109 at the contact surface. Normally, such energy will emanate from a generator that sends 109 energy (such as a transverse wave like light, or a longitudinal wave like ultrasound) through the platen, and when the energy reaches the contact surface, the energy will be reflected, absorbed or scattered, depending on what is contacting the contact surface. For example, if a ridge of a fingerprint is contacting the contact surface, most of the energy will be absorbed into the finger. Between the ridges of the fingerprint, the material in contact with the contact surface will not be skin, and is usually air, and in that situation, most of the energy will be reflected back through the platen and eventually reaches the detectors where the reflected energy is detected 112.

If ultrasonic energy is used, the ultrasonic energy detectors may receive reflected energy from the contact surface at different times due to the dome-shaped contact surface being further from some detectors than from others of the detectors. In that situation, each of the detectors may be associated with a time-delay window during which energy received by the detector is assumed to have been reflected from the interface at the contact surface of the platen. The time-delay window is a period of time during which energy reflected from the interface at the contact surface is expected to arrive at the detector. Thus, energy emanating from a planar generator will take longer to reach some detectors because the travel path of the energy is longer for some of the detectors than it is for others of the detectors. Those detectors associated with a short travel path will have a time-delay window that starts sooner than those detectors associated with a long travel path. To illustrate the idea, consider that in FIG. 4, the ultrasonic energy generators are the same devices as the detectors, and so the distance of the travel path is twice the distance (H) between the generator/detector element and the contact surface. It will be noticed that H for a detector 28 near the edge 25 is shorter than H for a detector 28 near the center of the platen 13.

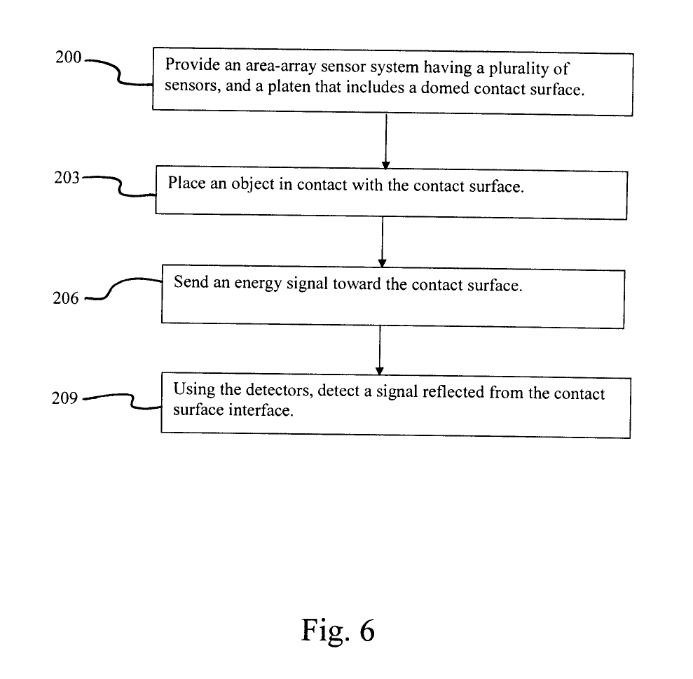

In a variation of the method described above, the object need not be moved across the platen. FIG. 6 is a flow chart showing steps of such a method. In such a method, an area-array sensor system is provided 200. The sensor system may have a plurality of detectors arranged in an area-array, and the sensor system has a dome-shaped platen. An object is placed 203 on the contact surface, and an energy signal is sent 206 toward the contact surface. At least some of the energy signal is reflected at the interface between the contact surface and the object, and the reflected energy then travels through the platen to the detectors, where the reflected energy is detected 209.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A sensor system, comprising:
a platen having a contact surface, at least part of the contact surface being dome-shaped; and,
a plurality of detectors.

2. The sensor system of claim 1, wherein the detectors are arranged in a line.

3. The sensor system of claim 1, wherein the detectors are arranged in an area-array.

4. The sensor system of claim 1, wherein the detectors are ultrasonic energy detectors.

5. The sensor system of claim 4, wherein each detector is associated with a time-delay window corresponding to a signal-travel-distance, and wherein some detectors have a time-delay window that starts sooner than the time-delay window of others of the detectors.

6. A method for collecting object surface information, comprising:
providing a sensor system having:
(i) a platen that has a contact surface, at least part of the contact surface being dome-shaped, and
(ii) a plurality of detectors;
emitting an energy signal toward the contact surface; and,
using the detectors to detect a signal reflected from the contact surface.

7. The method of claim 6, wherein the detectors are arranged in a line.

8. The method of claim 6, wherein the detectors are arranged in an area-array.

9. The method of claim 6, wherein the detectors are ultrasonic energy detectors.

10. The method of claim 9, wherein each detector is associated with a time-delay window corresponding to a signal-travel-distance, and wherein some detectors have a time-delay window that starts sooner than the time-delay window of others of the detectors.

11. The method of claim 6, further comprising moving an object surface across the contact surface.
